(19) United States
(12) Patent Application Publication
(10) Pub. No.: US 2009/0002242 A1
(43) Pub. Date: Jan. 1, 2009

(54) Housing for a portable electronic device

(75) Inventors: Harri Lasarov, Espoo (FI); Jussi Hakunti, Turku (FI); Pekka Kilpi, Helsinki (FI); Markku Heino, Espoo (FI); Andrew Strawn, Hants (GB); Simon James Quainton, Hampshire (GB); Petra Ollitervo, London (GB); James Eldon, Hants (GB); David Kevin Etherton, Hants (GB)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/823,198

(22) Filed: Jun. 26, 2007

(30) Foreign Application Priority Data
Jun. 30, 2006 (GB) 0612985.2

(51) Int. Cl. H01Q 1/24; H01Q 1/40

(52) U.S. Cl. 343/702; 343/873

(57) ABSTRACT

A housing for a portable electronic device including a housing portion; and an antenna element embedded within the housing portion, and operable at a resonant frequency, wherein the antenna element includes at least one folded portion and has a thickness substantially equal to at least four skin depths at the resonant frequency.

### FIELD OF THE INVENTION

Embodiments of the present invention relate to a housing for a portable electronic device. In particular, they relate to a housing for a mobile cellular telephone.

### BACKGROUND TO THE INVENTION

Portable electronic devices, such as mobile cellular telephones, typically include radio transceiver circuitry and an antenna arrangement which allows them to communicate with other such portable electronic devices. The antenna arrangement is usually positioned within a cavity of the housing of the portable electronic device and is mounted on a printed wiring board. One problem associated with this configuration is that the antenna arrangement may occupy a significant volume within the housing and thereby increase the overall size of the portable electronic device.

In order to address this problem, it is known to embed the antenna element within the housing of the portable electronic device. The current method for embedding an antenna element in a housing includes forming the antenna element on a carrier film using conductive ink and then injection moulding plastics material onto the conductive ink and carrier film to form the housing.

It would be desirable to provide an alternative housing, including an antenna element operable at high and low frequencies, for a portable electronic device.

### BRIEF DESCRIPTION OF THE INVENTION

According to one embodiment of the invention, there is provided a housing for a portable electronic device, comprising: a housing portion; and an antenna element, embedded within the housing portion, and operable at a resonant frequency, wherein the antenna element includes at least one folded portion and has a thickness substantially equal to at least four skin depths at the resonant frequency.

The antenna element may be operable at a resonant frequency of at least 0.125 MHz.

The antenna element may be operable at a resonant frequency of at least 13 MHz.

The thickness of the antenna element may allow a non linear current distribution flow across the thickness of the antenna element at the resonant frequency.

The antenna element and the housing portion may be unitary.

The antenna element may have a meandering shape. The antenna element may include at least one loop. The antenna element may include at least one loop which is arranged around a peripheral portion of an aperture in the housing portion.

The antenna element may be substantially rigid, to provide reinforcement of the housing portion. The surface area of the antenna element may be substantially equal to the surface area of the housing portion.

The housing portion may include a first portion and a second portion. The antenna element may be embedded within the housing portion between the first portion and the second portion.

The second portion may include an electromagnetic shield, positioned adjacent the antenna element, for reducing electromagnetic coupling between the antenna element and components of the portable electronic device.

The housing may alternatively further comprise an electromagnetic shield, positioned adjacent the antenna element, for reducing electromagnetic coupling between the antenna element and components of the portable electronic device.

The antenna element may comprise a material selected from the group comprising: aluminium, stainless steel, steel, titanium and copper.

According to another embodiment of the invention, there is provided a portable electronic device comprising a housing as described in the preceding paragraphs.

According to a further embodiment of the invention, there is provided a housing portion for coupling with one or more other housing portions of a portable electronic device, comprising: an antenna element, embedded within the housing portion, and operable at a resonant frequency, wherein the antenna element includes at least one folded portion and has a thickness substantially equal to at least four skin depths at the resonant frequency.

According to another embodiment of the invention, there is provided a method of forming a housing for a portable electronic device, comprising: embedding an antenna element within a housing portion, the antenna element being operable at a resonant frequency, wherein the antenna element has a thickness substantially equal to at least four skin depths at the resonant frequency.

The antenna element and the housing portion may be unitary.

The housing may be formed in a mould. The antenna element may be introduced into the mould and then formed therein.

According to a further embodiment of the invention there is provided a housing for a portable electronic device, comprising: a housing portion; and an antenna element, embedded within the housing portion, and being substantially rigid, to provide reinforcement of the housing portion.

The surface area of the antenna element may be substantially equal to the surface area of the housing portion.

### BRIEF DESCRIPTION OF THE DRAWINGS

For a better understanding of the present invention reference will now be made by way of example only to the accompanying drawings in which:

FIG. 1 illustrates a schematic diagram of a portable electronic device comprising an antenna arrangement embedded within at least a portion of the housing of the portable electronic device;

FIG. 2 illustrates a schematic cross sectional diagram of a first embodiment of a housing portion;

FIG. 3 illustrates a schematic cross sectional diagram of a second embodiment of a housing portion;

FIG. 4 illustrates a flow diagram of a method of forming a housing for a portable electronic device;

FIG. 5 illustrates a perspective diagram of a front face of a portable electronic device according to a first embodiment of the present invention;

FIG. 6 illustrates a perspective diagram of a back face of the portable electronic device illustrated in FIG. 5;

FIG. 7 illustrates a perspective diagram of a portable electronic device and a housing portion which may be coupled thereto according to a second embodiment of the present invention;

FIG. 8 illustrates a perspective diagram of a portable electronic device according to a third embodiment of the present invention;

FIG. 9 illustrates a perspective diagram of a portable electronic device according to a fourth embodiment of the present invention;

FIG. 10 illustrates a perspective diagram of a portable electronic device according to a fifth embodiment of the present invention;

FIG. 11 illustrates a cross sectional diagram of a portion of the portable electronic device illustrated in FIG. 10;

FIG. 12 illustrates a perspective diagram of a portable electronic device according to a sixth embodiment of the present invention;

FIG. 13 illustrates a cross sectional diagram of a portion of the portable electronic device illustrated in FIG. 12;

FIG. 14 illustrates a perspective diagram of a portable electronic device according to a seventh embodiment of the present invention;

FIG. 15 illustrates a cross sectional diagram of a portion of the portable electronic device illustrated in FIG. 14;

FIG. 16 illustrates a perspective diagram of a portable electronic device according to an eighth embodiment of the present invention; and

FIG. 17 illustrates a cross sectional diagram of a portion of the portable electronic device illustrated in FIG. 16.

### DETAILED DESCRIPTION OF EMBODIMENTS OF THE INVENTION

The figures illustrate a housing 12 for a portable electronic device 10, comprising: a housing portion; and an antenna element 24, 28, 50, 56, 62, 74, 86, 94 embedded within the housing portion, and operable at a resonant frequency, wherein the antenna element 24, 28, 50, 56, 62, 74, 86, 94 includes at least one folded portion and has a thickness substantially equal to at least four skin depths at the resonant frequency.

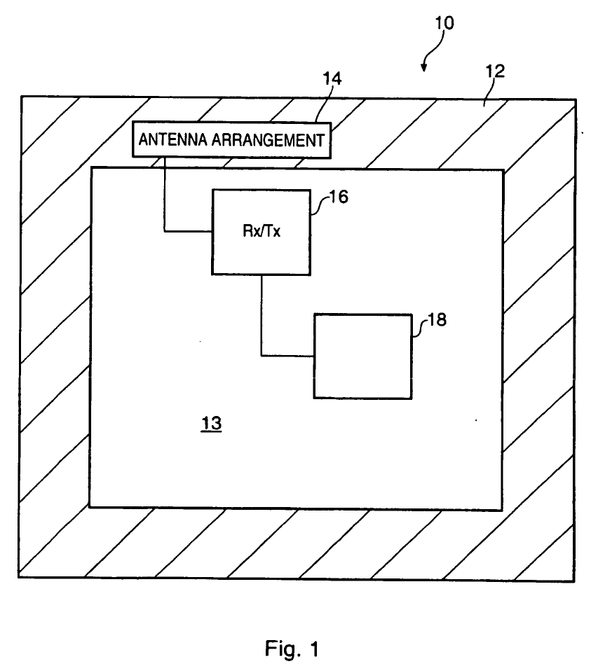

In more detail, FIG. 1 illustrates a schematic diagram of a portable electronic device 10 such as a mobile cellular telephone, laptop computer, other radio communication device or module for such devices. The portable electronic device 10 comprises a housing 12 which defines a cavity 13, an antenna arrangement 14, radio transceiver circuitry 16 and functional circuitry 18. The antenna arrangement 14 is connected to the radio transceiver circuitry 16, which is in turn connected to the functional circuitry 18. In the embodiment where the portable electronic device 10 is a mobile cellular telephone, the functional circuitry 18 includes a processor, a memory and input/output devices such as a microphone, a loudspeaker and a display. Typically the electronic components that provide the radio transceiver circuitry 16 and functional circuitry 18 are interconnected via a printed wiring board (PWB, not illustrated in the figure).

The antenna arrangement 14 is embedded within at least a portion of the housing 12 and is unitary with the housing 12. The radio transceiver circuitry 16 and the functional circuitry 18 are located in the cavity 13 of the housing 12. In this embodiment, the antenna arrangement 14 only includes a single antenna element embedded within the housing 12. However, it should be appreciated that in other embodiments, the antenna arrangement 14 may include one or more antenna elements embedded within the housing 12 and optionally, one or more antenna elements mounted on the printed wiring board within the cavity 13 of the housing 12 (i.e. not embedded within the housing 12). The antenna arrangement 14 may include any combination of RFID antennas (operable at resonant frequencies of approximately 0.125 MHz to 930 MHz), FM antennas (operable at resonant frequencies of approximately 30 to 300 MHz), FM TX antennas (operable at resonant frequencies of approximately 30 to 300 MHz), DVB-H antennas (operable at resonant frequencies of approximately 400 MHz to 800 MHz) and GSM antennas (operable at resonant frequencies of approximately 800 MHz to 2400 MHz). The antenna element(s) of the antenna arrangement 14 may comprise aluminium, stainless steel, steel, titanium or copper.

One advantage of having at least one antenna element of the antenna arrangement 14 embedded within the housing 12 is that it may result in a thinner portable electronic device 10 since the embedded antenna element will not require any space within the cavity 13 of the housing 12. Additionally, the portable electronic device 10 may be assembled more quickly since the antenna element which is embedded in the housing will not require mounting on the printed wiring board within the cavity 13.

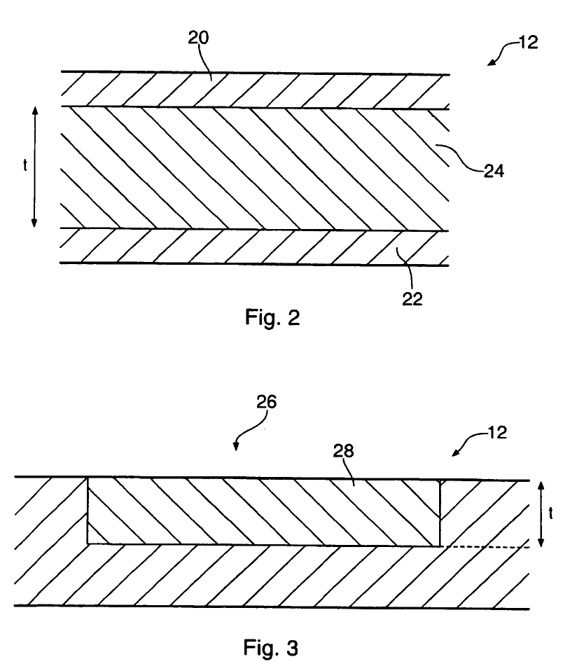

FIG. 2 illustrates a schematic cross sectional diagram of a first embodiment of a housing portion 12. In this embodiment, the housing portion 12 includes a first portion 20 and a second portion 22. An antenna element 24 is embedded in the housing portion 12 and is sandwiched between the first portion 20 and the second portion 22. The antenna element 24 includes at least one folded portion (not illustrated in this figure) and is unitary with the housing portion 12. The first portion 20 and the second portion 22 may comprise the same material or different materials. In one embodiment, the first portion 20 and the second portion 22 comprise a plastics material.

In one embodiment, the antenna element 24 has a thickness (t) which is equal to at least four skin depths at a resonant frequency of 13 MHz. Consequently, the antenna element 24 may be operable as an RFID antenna. In this embodiment, the antenna element 24 comprises copper, has a thickness of 72 μm and is operable at a resonant frequency of 13.56 MHz.

In another embodiment, the antenna element 24 has a thickness (t) which is equal to at least four skin depths at a resonant frequency of 0.125 MHz. In this embodiment, the antenna element 24 comprises copper and has a thickness of approximately 740 μm at the resonant frequency of 0.125 MHz. The concept of ‘skin depth’ is well known within the art of electromagnetics and will consequently not be described in detail here.

One advantage provided by an antenna element having a thickness equal to at least four skin depths at an operational resonant frequency is that it may operate efficiently at that operational frequency. If the thickness of the antenna element is less than four skin depths, the antenna element will not operate efficiently as it will be too lossy.

FIG. 3 illustrates a schematic cross sectional diagram of a second embodiment of a housing portion 12. In this embodiment, the housing portion 12 comprises a plastics material and includes a receptacle 26. An antenna element 28 is embedded within the housing portion 12 and is positioned in the receptacle 26. The housing portion 12 and the antenna element 28 are unitary. Additionally, the antenna element 28 includes at least one folded portion (not illustrated in this figure). As described above with reference to FIG. 2, the antenna element 28 may have a thickness (t) which is equal to at least four skin depths at a resonant frequency of 0.125 MHz or 13 MHz.

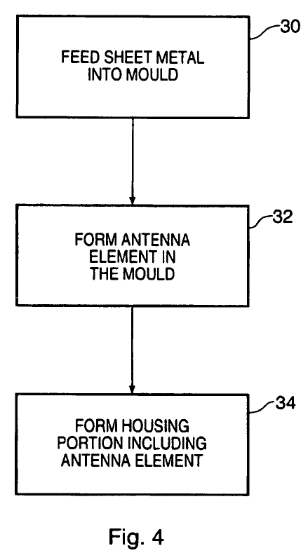

FIG. 4 illustrates a flow diagram of a method for forming a housing portion of a portable electronic device. Initially in step 30, sheet metal is fed as a continuous body of material into a mould. Then in step 32, an antenna element is formed in the mould from the sheet metal. The step of forming the antenna element includes cutting the sheet metal to a predetermined desired configuration and then shaping it to a desired shape. The step of forming an antenna element is carried out by appropriate cutting and shaping means which may be controlled by a processor (such as microprocessor). In step 34, the antenna element is embedded in a housing portion as plastics material is injection moulded onto the antenna element to form the housing portion.

In one embodiment, the sheet metal/antenna element is coupled to the plastics material using in-mould bonding. Since the mechanical bond between the sheet metal/antenna element and the plastics material is relatively strong, this process may provide a thinner and mechanically stronger housing portion.

Alternatively, the antenna may be placed on a mounting which is substantially shaped as at least a portion of a housing. The housing portion may then be formed by spraying plastic material onto the antenna and the mounting thereby reducing the amount of plastic material required.

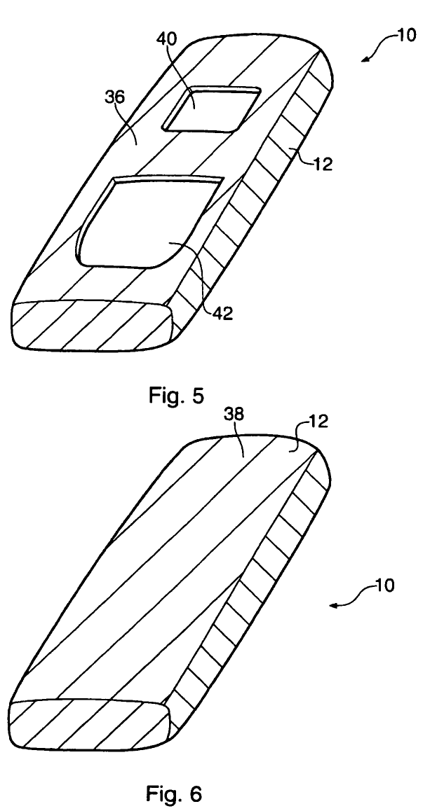

FIGS. 5 and 6 illustrate perspective diagrams of a front face 36 and a back face 38 of a housing 12 respectively, according to a first embodiment of the present invention. The front face 36 includes a first aperture 40 for receiving a display of a portable electronic device, and a second aperture 42 for receiving a keypad of the portable electronic device. In this embodiment, the antenna element (indicated by shading) is embedded within the housing 12 and has a shape that is similar to that of the housing 12 (i.e. it has a front surface that has a shape which corresponds with the front face 36, a back surface that has a shape which corresponds with the back face 38 and surfaces which extend between the front and back surfaces). Consequently, in this embodiment, the antenna element includes a plurality of surfaces which are folded relative to one another (for example, the front surface is folded with respect to the back surface). Additionally, the surface area of the antenna element is substantially equal to the surface area of the housing 12. Additionally, the antenna element is substantially rigid and thereby provides reinforcement for substantially the whole of the housing 12.

One advantage provided by this embodiment is that the antenna element increases the mechanical strength and robustness of the housing and may permit the volume of plastic in the housing to be substantially reduced. In other embodiments, the antenna element may be substantially rigid, but the surface area of the antenna element is less than the surface area of the housing. In these embodiments, the antenna element may only reinforce a portion of the housing 12.

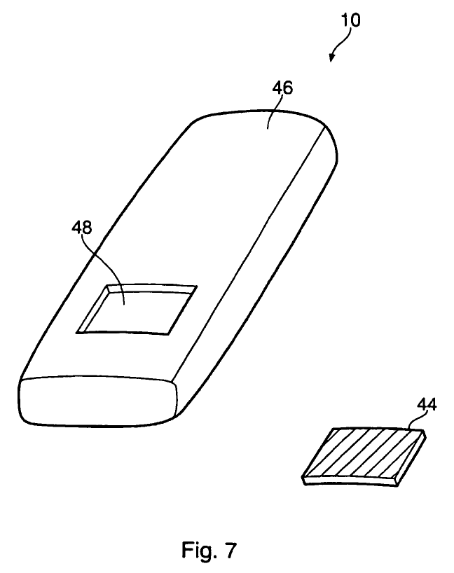

FIG. 7 illustrates a perspective diagram of a back face of a portable electronic device 10 and a housing portion 44 which may be coupled thereto. In this embodiment, the housing 46 defines an aperture 48 which is arranged to receive the housing portion 44. In other embodiments, the housing 46 may define a receptacle which is arranged to receive the housing portion 44. The housing portion 44 includes an antenna element (indicated by shading) embedded therein, in accordance with embodiments of the present invention.

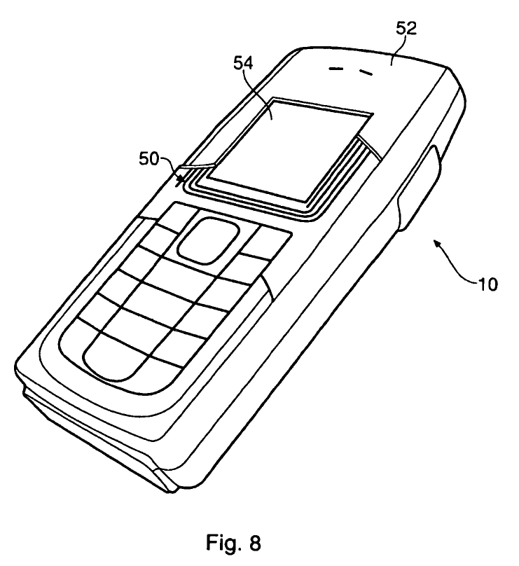

FIG. 8 illustrates a perspective diagram of a portable electronic device 10 according to a third embodiment of the present invention. In this embodiment, an antenna element 50 is embedded in the front cover 52 of the portable electronic device 10 around the display 54. The antenna element 50 is arranged in a series of loops around the display 54 and consequently includes a plurality of portions which are folded with respect to one another.

FIG. 9 illustrates a perspective diagram of a portable electronic device 10 according to a fourth embodiment of the present invention. In this embodiment, an antenna element 56 is embedded in the front cover 58 of the portable electronic device 10 around the keypad 60. The antenna element 56 is arranged in a series of loops around the keypad 60 and consequently includes a plurality of portions which are folded with respect to one another.

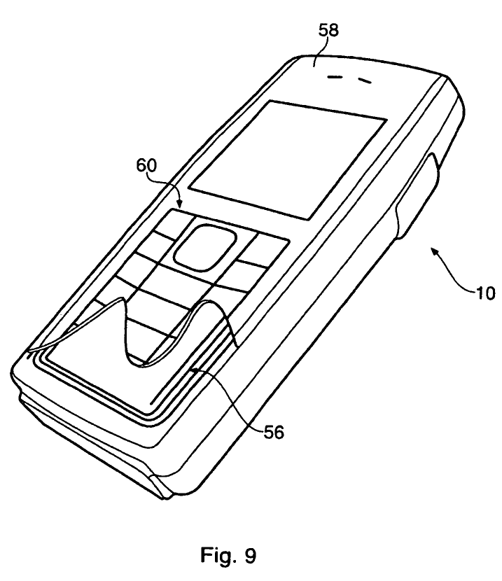

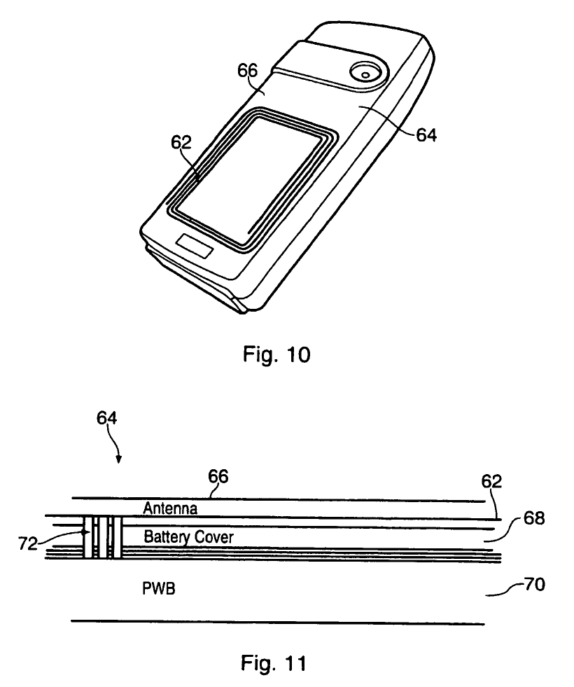

FIG. 10 illustrates a perspective diagram of a portable electronic device 10 according to a fifth embodiment of the present invention. In this embodiment, an antenna element 62 is embedded in the back cover 64 of the portable electronic device 10. As illustrated in FIG. 11, the antenna element 64 is embedded in the back cover 64 between a first portion 66 and a second portion 68 (as in FIG. 2). The antenna element 62 is connected to radio transceiver circuitry 16, mounted on printed wiring board 70, via connectors 72. In an alternative arrangement, the antenna may have an indirect feed so that connectors 72 are not required. The antenna element 62 is arranged in a series of loops consequently includes a plurality of portions which are folded with respect to one another.

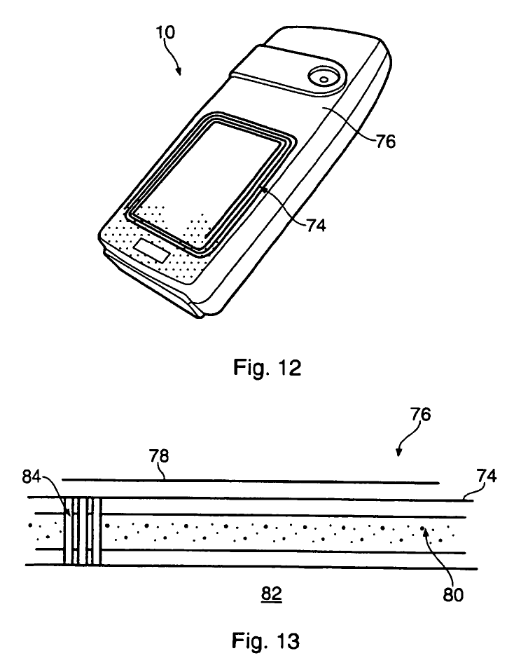

FIG. 12 illustrates a perspective diagram of a portable electronic device 10 according to a sixth embodiment of the present invention. In this embodiment, an antenna element 74 is embedded in the back cover 76 of the portable electronic device 10. As illustrated in FIG. 13, the antenna element 74 is embedded in the back cover 76 between a first portion 78 and a second portion 80 (as in FIG. 2). The antenna element 74 is arranged in a series of loops and consequently includes a plurality of portions which are folded with respect to one another. The antenna element 74 is connected to radio transceiver circuitry 16, mounted on printed wiring board 82, via connectors 84. The first portion 78 comprises a plastics material and the second portion 80 comprises a ferrite for reducing electromagnetic coupling between the antenna element 74 and components on the printed wiring board 82.

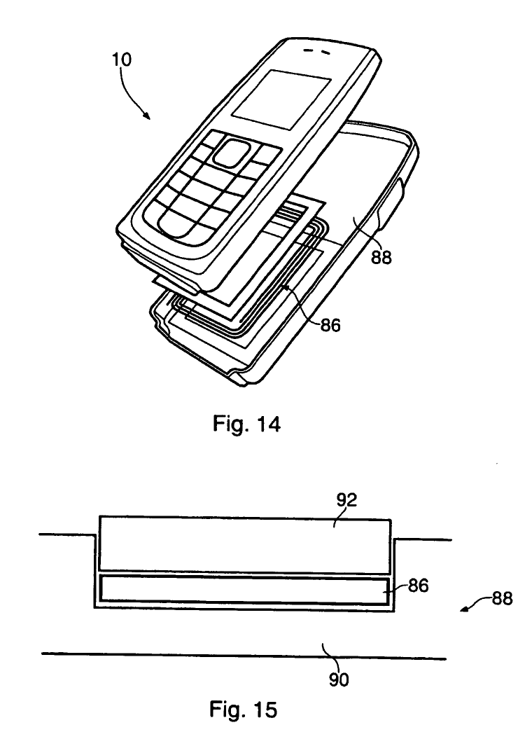

FIG. 14 illustrates a perspective diagram of a portable electronic device 10 according to a seventh embodiment of the present invention. In this embodiment, an antenna element 86 is embedded in the back cover 88 of the portable electronic device 10. As illustrated in FIG. 15, the antenna element 86 is embedded in the back cover 88 (as in FIG. 3) between a first portion 90 and a second portion 92. The antenna element 86 is arranged in a series of loops and consequently includes a plurality of portions which are folded with respect to one another. The first portion 90 comprises a plastics material and the second portion 92 comprises a ferrite for reducing electromagnetic coupling between the antenna element 86 and components on the printed wiring board (not illustrated in the figure).

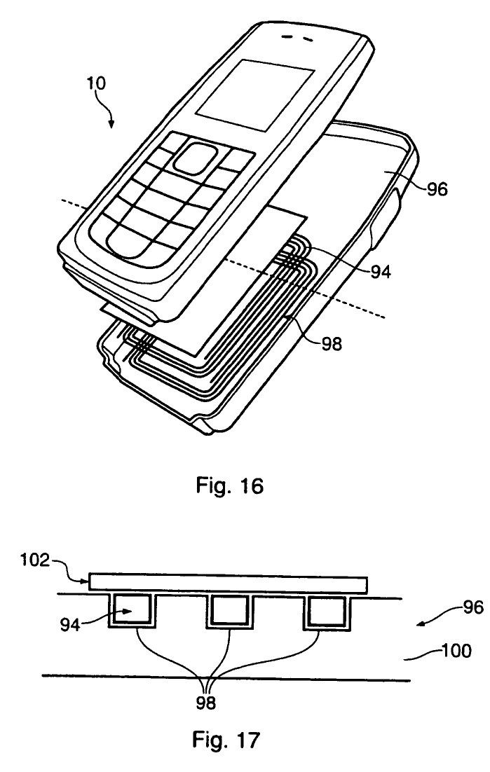

FIG. 16 illustrates a perspective diagram of a portable electronic device 10 according to an eighth embodiment of the present invention. In this embodiment, an antenna element 94 is embedded in the back cover 96 of the portable electronic device 10 (as in FIG. 3). In more detail and as illustrated in FIG. 17, the antenna element 94 is positioned within grooves 98 in a first portion 100 of the back cover 96 and is sandwiched between the first portion 100 and a second portion 102. The antenna element 94 is arranged in a series of loops and consequently includes a plurality of portions which are folded with respect to one another. The first portion 100 comprises a plastics material and the second portion 102 comprises a ferrite for reducing electromagnetic coupling between the antenna element 94 and components on the printed wiring board (not illustrated in the figure).

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A housing for a portable electronic device, comprising:
a housing portion; and
an antenna element, embedded within the housing portion, and operable at a resonant frequency, wherein the antenna element includes at least one folded portion and has a thickness substantially equal to at least four skin depths at the resonant frequency.

2. A housing as claimed in claim 1, wherein the antenna element is operable at a resonant frequency of at least 0.125 MHz.

3. A housing as claimed in claim 1, wherein the antenna element is operable at a resonant frequency of at least 13 MHz.

4. A housing as claimed in claim 1, wherein the antenna element and the housing portion are unitary.

5. A housing as claimed in claim 1, wherein the antenna element has a meandering shape.

6. A housing as claimed in claim 1, wherein the antenna element includes at least one loop.

7. A housing as claimed in claim 1, wherein the antenna element includes at least one loop which is arranged around a peripheral portion of an aperture in the housing portion.

8. A housing as claimed claim 1, wherein the antenna element is substantially rigid, to provide reinforcement of the housing portion.

9. A housing as claimed in claim 1, wherein the surface area of the antenna element is substantially equal to the surface area of the housing portion.

10. A housing as claimed in claim 1, wherein the housing portion includes a first portion and a second portion, and the antenna element is embedded within the housing portion between the first portion and the second portion.

11. A housing as claimed in claim 10, wherein the second portion includes an electromagnetic shield, positioned adjacent the antenna element, for reducing electromagnetic coupling between the antenna element and components of the portable electronic device.

12. A housing as claimed in claim 1, further comprising an electromagnetic shield, positioned adjacent the antenna element, for reducing electromagnetic coupling between the antenna element and components of the portable electronic device.

13. A housing as claimed in claim 1, wherein the antenna element comprises a material selected from the group comprising: aluminium, stainless steel, steel, titanium and copper.

14. (canceled)

15. A portable electronic device comprising a housing as claimed in claim 1.

16. A housing portion for coupling with one or more other housing portions of a portable electronic device, comprising:
an antenna element, embedded within the housing portion, and operable at a resonant frequency, wherein the antenna element includes at least one folded portion and has a thickness substantially equal to at least four skin depths at the resonant frequency.

17. A method of forming a housing for a portable electronic device, comprising:
embedding an antenna element within a housing portion, the antenna element being operable at a resonant frequency, wherein the antenna element has a thickness substantially equal to at least four skin depths at the resonant frequency.

18. A method as claimed in claim 17, wherein the antenna element and the housing portion are unitary.

19. A method as claimed in claim 17, wherein the housing is formed in a mould.

20. A method as claimed in claim 19, wherein the antenna element is introduced into the mould and then formed therein.

21. (canceled)

22. A housing for a portable electronic device, comprising:
a housing portion; and
an antenna element, embedded within the housing portion, and being substantially rigid, to provide reinforcement of the housing portion.

23. A housing as claimed in claim 22, wherein the surface area of the antenna element is substantially equal to the surface area of the housing portion.
